(19) United States
(12) Patent Application Publication
(10) Pub. No.: US 2006/0250945 A1
(43) Pub. Date: Nov. 9, 2006

(54) Method and apparatus for automatically activating standby shared Ethernet adapter in a Virtual I/O server of a logically-partitioned data processing system

(75) Inventors: Lilian S. Fernandes, Bangalore (IN); Vinit Jain, Austin, TX (US); Jorge Rafael Nogueras, Austin, TX (US); Vasu Vallabhaneni, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/101,619

(22) Filed: Apr. 7, 2005

(51) Int. Cl. H04L 12/26

(52) U.S. Cl. 370/216

(57) ABSTRACT

A method, an apparatus, and computer instructions are provided for automatically activating standby shared Ethernet adapter in a Virtual I/O server of a logically-partitioned data processing system. A standby shared Ethernet adapter (SEA) is set up with a virtual Ethernet adapter that belongs to the same network as the primary shared Ethernet adapter (SEA). The standby SEA monitors periodically for a failure of the primary SEA. If a failure occurs, the standby SEA is activated by connecting a path between its physical adapter and virtual trunk adapter, such that the virtual trunk adapter becomes the primary SEA for the client partitions. Responsive to detecting a recovery of the primary SEA, the primary SEA determines if external communications are received from the standby SEA. If no external communications are received, the primary SEA is reactivated by connecting a path between its physical adapter and virtual trunk adapter.

### BACKGROUND OF THE INVENTION

1. Technical Field

The present invention relates to an improved data processing system. In particular, the present invention relates to a shared Ethernet adapter in a Virtual I/O server of a logically-partitioned data processing system. More specifically, the present invention relates to automatically activating a standby shared Ethernet adapter (SEA) in a Virtual I/O server of the logically-partitioned data processing system.

2. Description of Related Art

Increasingly large symmetric multi-processor data processing systems, such as IBM eServer P690, available from International Business Machines Corporation, DHP9000 Superdome Enterprise Server, available from Hewlett-Packard Company, and the Sunfire 15K server, available from Sun Microsystems, Inc. are not being used as single large data processing systems. Instead, these types of data processing systems are being partitioned and used as smaller systems. These systems are also referred to as logically-partitioned (LPAR) data processing systems.

The logical partition (LPAR) functionality within a data processing system allows multiple copies of a single operating system or multiple heterogeneous operating systems to be simultaneously run on a single data processing system platform. A partition, within which an operating system image runs, is assigned a non-overlapping subset of the platforms resources. These platform allocatable resources include one or more architecturally distinct processors with their interrupt management area, regions of system memory, and input/output (I/O) adapter bus slots. The partitions resources are represented by the platforms firmware to the operating system image.

Each distinct operating system or image of an operating system running within a platform is protected from each other such that software errors on one logical partition cannot affect the correct operations of any of the other partitions. This protection is provided by allocating a disjointed set of platform resources to be directly managed by each operating system image and by providing mechanisms for insuring that the various images cannot control any resources that have not been allocated to that image.

Furthermore, software errors in the control of an operating systems allocated resources are prevented from affecting the resources of any other image. Thus, each image of the operating system or each different operating system directly controls a distinct set of allocatable resources within the platform.

With respect to hardware resources in a logically-partitioned data processing system, these resources are disjointly shared among various partitions. These resources may include, for example, input/output (I/O) adapters, memory DIMMs, non-volatile random access memory (NVRAM), and hard disk drives. Each partition within an LPAR data processing system may be booted and shut down multiple times without having to power-cycle the entire data processing system.

In a logically-partitioned data processing system, such as a POWER5 system, a logical partition communicates with external networks via a special partition known as a Virtual I/O server (VIOS). The Virtual I/O server provides I/O services, including network, disk, tape, and other access to partitions without requiring each partition to own a device.

Within the Virtual I/O server, a network access component known as shared Ethernet adapter (SEA) is used to bridge between a physical Ethernet adapter and one or more virtual Ethernet adapters. A physical Ethernet adapter is used to communicate outside of the hardware system, while a virtual Ethernet adapter is used to communicate between partitions of the same hardware system.

The shared Ethernet adapter allows logical partitions on the Virtual Ethernet to share access to the physical Ethernet and communicates with standalone servers and logical partitions on other systems. The access is enabled by connecting internal VLANs with VLANs on external Ethernet switches. The Virtual Ethernet adapters that are used to configure a shared Ethernet adapter are trunk adapters. The trunk adapters cause the virtual Ethernet adapters to operate in a special mode, such that packets that are addressed to an unknown hardware address, for example, packets for external systems, may be delivered to the external physical switches.

Since Virtual I/O server serves as the only physical contact to the outside world, if the Virtual I/O server fails for arbitrary reasons, including system crashes, hardware adapter failures, etc., other logical partitions that use the same Virtual I/O server for external communications via SEA will also fail. Currently, the communications are disabled until the SEA in the Virtual I/O server is up and running again. There is no existing mechanism that facilitates communications while the SEA is down.

Therefore, it would be advantageous to have an improved method for automatically activating a standby shared Ethernet adapter (SEA), such that when the primary shared Ethernet adapter in a Virtual I/O server fails, a backup SEA can be used to maintain communications.

### SUMMARY OF THE INVENTION

The present invention provides a method, an apparatus, and computer instructions in a logically-partitioned data processing system for automatically activating a standby shared Ethernet adapter. The mechanism of the present invention first sets up the standby shared Ethernet adapter (SEA) using a virtual Ethernet adapter that belongs to a same network as a primary shared Ethernet adapter. The standby SEA then periodically monitors external communications received from the primary shared Ethernet adapter for a failure. If a failure is detected, the mechanism of the present invention activates the standby shared Ethernet adapter as the primary shared Ethernet adapter.

Responsive to a recovery of the primary shared Ethernet adapter, the mechanism of the present invention sets up the primary shared Ethernet adapter to receive external communications from the standby shared Ethernet adapter. The primary SEA then determines if external communications are received from the standby shared Ethernet adapter. If no external communications are received from the standby shared Ethernet adapter, the primary shared Ethernet adapter is reactivated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of an exemplary logically-partitioned platform in which the present invention may be implemented;

FIG. 3 is a diagram illustrating a known virtual local area network (VLAN) used in a logically-partitioned data processing system;

FIG. 4 is a diagram illustrating a known virtual Ethernet in a logically-partitioned data processing system;

FIG. 5 is a diagram illustrating a shared Ethernet adapter in a Virtual I/O server of a logically-partitioned data processing system in accordance with an illustrative embodiment of the present invention;

FIG. 6 is a diagram illustrating a primary shared Ethernet adapter and standby shared Ethernet adapter in a Virtual I/O server of a logically-partitioned data processing system in accordance with an illustrative embodiment of the present invention;

FIG. 7 is a flowchart of an exemplary process for automatically activating a standby shared Ethernet adapter in accordance with an illustrative embodiment of the present invention; and

FIG. 8 is a flowchart of an exemplary process for reactivating a primary shared Ethernet adapter after recovery in accordance with an illustrative embodiment of the present invention.

### DETAILED DESCRIPTION OF THE PREFERRED EMBODIMENT

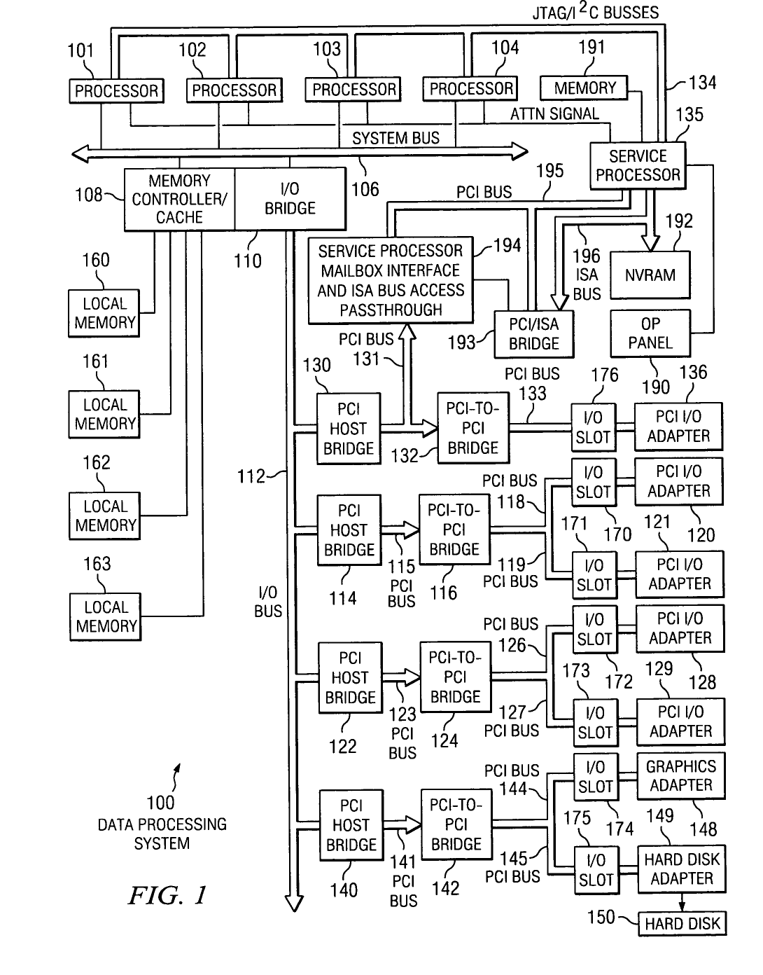

With reference now to the figures, and in particular with reference to FIG. 1, a block diagram of a data processing system in which the present invention may be implemented is depicted. Data processing system 100 may be a symmetric multiprocessor (SMP) system including a plurality of processors 101, 102, 103, and 104 connected to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logically-partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Linux or OS/400 operating system may be operating within logical partition P3.

Peripheral component interconnect (PCI) host bridge 114 connected to I/O bus 112 provides an interface to PCI local bus 115. A number of PCI input/output adapters 120-121 may be connected to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations will support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 is connected to a plurality of PCI I/O adapters 128-129. PCI I/O adapters 128-129 may be connected to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. In this manner, data processing system 100 allows connections to multiple network computers.

A memory mapped graphics adapter 148 inserted into I/O slot 174 may be connected to I/O bus 112 through PCI bus 144, PCI-to-PCI bridge 142, PCI bus 141 and PCI host bridge 140. Hard disk adapter 149 may be placed into I/O slot 175, which is connected to PCI bus 145. In turn, this bus is connected to PCI-to-PCI bridge 142, which is connected to PCI host bridge 140 by PCI bus 141.

A PCI host bridge 130 provides an interface for a PCI bus 131 to connect to I/O bus 112. PCI I/O adapter 136 is connected to I/O slot 176, which is connected to PCI-to-PCI bridge 132 by PCI bus 133. PCI-to-PCI bridge 132 is connected to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

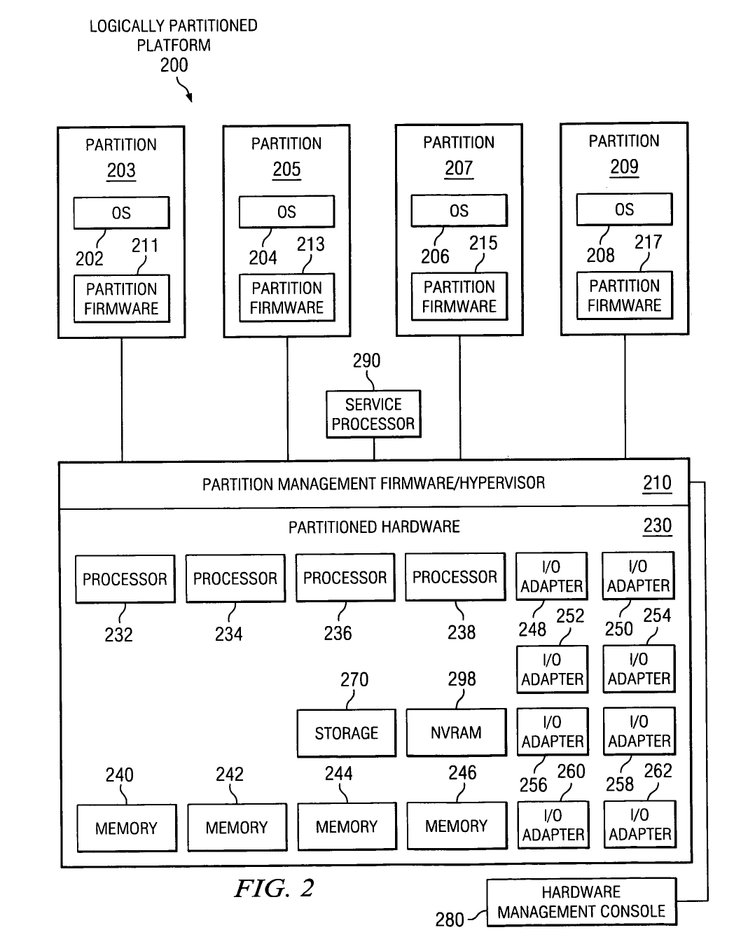

With reference now to FIG. 2, a block diagram of an exemplary logically-partitioned platform is depicted in which the present invention may be implemented. The hardware in logically-partitioned platform 200 may be implemented as, for example, data processing system 100 in FIG. 1. Logically-partitioned platform 200 includes partitioned hardware 230, operating systems 202, 204, 206, 208, and partition management firmware/Hypervisor 210. Operating systems 202, 204, 206, and 208 may be multiple copies of a single operating system or multiple heterogeneous operating systems simultaneously run on logically-partitioned platform 200. These operating systems may be implemented using OS/400, which are designed to interface with a partition management firmware, such as Hypervisor. OS/400 is used only as an example in these illustrative embodiments. Of course, other types of operating systems, such as AIX and Linux, may be used depending on the particular implementation. Operating systems 202, 204, 206, and 208 are located in partitions 203, 205, 207, and 209, respectively. Hypervisor software is an example of software that may be used to implement partition management firmware/Hypervisor 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial bootstrap code, IEEE-1275 Standard Open Firmware, and runtime abstraction software (RTAS), which is available from International Business Machines Corporation. When partitions 203, 205, 207, and 209 are instantiated, a copy of bootstrap code is loaded onto partitions 203, 205, 207, and 209 by platform firmware 210. Thereafter, control is transferred to the bootstrap code with the bootstrap code then loading the open firmware and RTAS. The processors associated or assigned to the partitions are then dispatched to the partitions' memory to execute the partition firmware.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of multiple partitions within logically-partitioned platform 200, each of which corresponds to one of operating systems 202, 204, 206, and 208.

Partition management firmware/Hypervisor 210 performs a number of functions and services for partitions 203, 205, 207, and 209 to create and enforce the partitioning of logically-partitioned platform 200. Partition management firmware/Hypervisor 210 is a firmware implemented virtual machine identical to the underlying hardware. Thus, partition management firmware/Hypervisor 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including the reallocation of resources to different partitions.

The present invention provides a method, an apparatus, and computer instructions for automatically activating a standby shared Ethernet adapter in a Virtual I/O server of a logically-partitioned data processing system. The mechanism of the present invention may be implemented using a virtual Ethernet adapter that belongs to the same network as the primary shared Ethernet adapter, in order to set up a standby Ethernet adapter.

The mechanism of the present invention sets up the standby shared Ethernet adapter by disabling the path through its physical Ethernet adapters, such that standby shared Ethernet adapter can receive external network connectivity through the primary shared Ethernet adapter. Periodically, the standby shared Ethernet adapter monitors connectivity to external systems and detects any failure, similar to other users of the primary shared Ethernet adapter. The standby shared Ethernet adapter detects the failure using services provided by the primary shared Ethernet adapter without involving any intermediary status monitoring mechanism. Thus, failsafe functions may be provided at a granular level, which is the shared Ethernet adapter level, as opposed to the Virtual I/O server level.

When the standby shared Ethernet adapter detects a failure, the standby Ethernet adapter activates its virtual Ethernet adapters as trunk adapter by making a call to Hypervisor, such that it becomes the primary shared Ethernet adapter. The Hypervisor then completes its operations and switches all client logical partitions that were using the primary shared Ethernet adapter to the standby shared Ethernet adapter.

If later the primary shared Ethernet adapter recovers, it determines whether the standby shared Ethernet adapter is running as the primary adapter without making a separate call to the Hypervisor. Similar to the standby shared Ethernet adapter, the primary shared Ethernet adapter disables its physical adapter and verifies external connectivity.

If external connectivity is found, the primary shared Ethernet adapter realizes that the standby shared Ethernet adapter is providing connectivity. However, if external connectivity is not found, the primary shared Ethernet adapter realizes that the standby shared Ethernet adapter is not providing connectivity and thus issues a call to the Hypervisor indicating that it is now the primary shared Ethernet adapter.

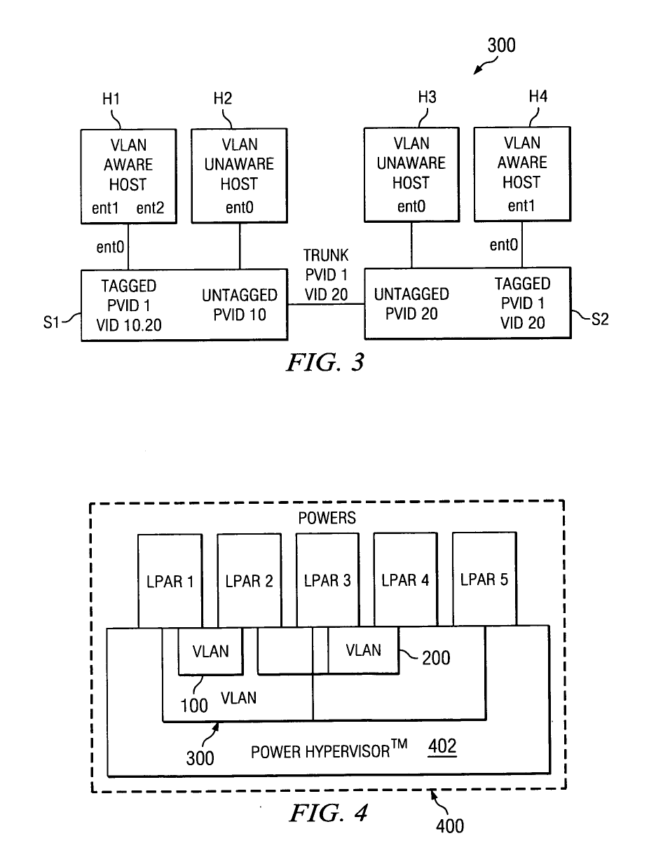

Turning now to FIG. 3, a diagram illustrating a known virtual local area network (VLAN) used in a logically-partitioned data processing system is depicted. As shown in FIG. 3, VLAN 300 restricts communications to members that belong to the same VLAN. This separation is achieved by tagging Ethernet packets with their VLAN membership information and restricting delivery of the packet to only members of the VLAN. The membership information is known as VLAN ID or VID.

In an Ethernet switch, ports of the switch are configured as members of VLAN designated by the VID for that port. The default VID for a port is known as Port VID (PVID). The VID may be tagged to an Ethernet packet either by a VLAN-aware host or by the switch in case of VLAN-unaware hosts. For unaware hosts, a port is set up as untagged. The switch will tag all entering packets with the PVID and untag all exiting packets before delivering the packet to the host. Thus, the host may only belong to a single VLAN identified by its PVID. For aware hosts, since they can insert or remove their own tags, the ports to which the aware hosts are attached do not remove the tags before delivering to the hosts, but will insert the PVID tag when an untagged packet enters the port. In addition, aware hosts may belong to more than one VLAN.

In this example, hosts H1 and H2 share VLAN 10 while H1, H3, and H4 share VLAN 20. Since H1 is an aware host, switch S1 tags all entering packets with PVID 1 before delivering the packet to H1. However, since H2 is an unaware host, switch S1 only tags PVID 10 to packets that are entering the port.

To tag or untag Ethernet packets, a VLAN device, such as ent1, is created over a physical or virtual Ethernet device, such as ent0, and assigned a VLAN tag ID. An IP address is then assigned on the resulting interface (en1) associated with the VLAN device.

Turning now to FIG. 4, a diagram illustrating a known virtual Ethernet in a logically-partitioned data processing system is depicted. As shown in FIG. 4, a logically-partitioned data processing system, such as POWER5 system 400, logical partitions may communicate with each other by using virtual Ethernet adapters (not shown) and assigning VIDs that enable them to share a common logical network.

Virtual Ethernet adapters (not shown) are created and VID assignments are performed using Hardware management console, such as hardware management console 280 in FIG. 2. Typically, each logical partition has its own virtual Ethernet adapter. Once the virtual adapters are created for a logical partition, the operating system in the partition recognizes the adapter as a virtual Ethernet device. In this example, LPAR1, and 2 may communicate with each other and are assigned VID VLAN 100. LPAR 2, 3, and 4 may communicate with each other and are assigned VID VLAN 200. LPAR 1, 3, and 5 may communicate with each other and are assigned VID VLAN 300. Power Hypervisor 402 transmit packets by copying the packet directly from the memory of the sender partition to the receiving buffers of the receiver partition without any intermediate buffering of the packet.

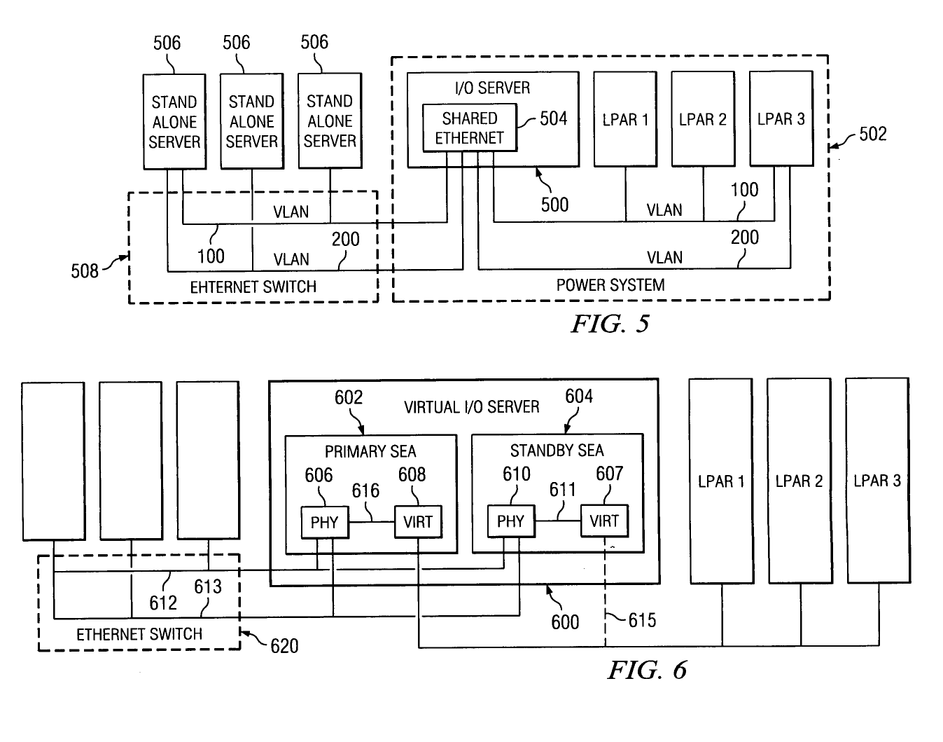

Turning now to FIG. 5, a diagram illustrating a shared Ethernet adapter in a Virtual I/O server of a logically-partitioned data processing system is depicted in accordance with an illustrative embodiment of the present invention. As shown in FIG. 5, while virtual Ethernet adapters allows logical partitions on the same system to communicate with each other, access to outside networks requires physical Ethernet adapters.

In this example, LPAR 1, 2 and 3 are similar to LPAR 1, 2, and 3 in FIG. 4, except that LPAR 1 and 2 are connected to shared Ethernet adapter 504 via VLAN 100, while LPAR 1 and 3 are connected to shared Ethernet adapter 504 via VLAN 200. Thus, shared Ethernet adapter 504 enables LPARs 1, 2 and 3 on virtual Ethernet in POWER5 system 502 to share access to physical adapter and communicate with standalone servers 506. This shared access is enabled by connecting internal Hypervisor VLANs, such as VLAN 100 and VLAN 200, with VLANs on external switches, in this example, VLAN 100 and VLAN 200 on Ethernet switch 508. With shared Ethernet adapter 504, LPAR 1, 2, and 3 in POWER5 system 502 which share the same IP subnet may communicate with external standalone servers 506.

In order to configure shared Ethernet adapter 504, virtual Ethernet adapters are required to have trunk settings enabled from HMC. The trunk settings enable the virtual adapters to operation in special mode, such that they can deliver and accept external packets from the POWER5 system internal switch to external physical switches. With the trunk settings, a virtual adapter becomes a virtual Ethernet trunk adapter for all VLANs that it belongs to. When shared Ethernet adapter 504 is configured, one or more physical Ethernet adapters are assigned to a logical partition and one or more virtual Ethernet trunk adapter are defined. In cases when shared Ethernet adapter 504 fails, there is no existing mechanism that detects the failure and performs failsafe functions.

To alleviate this problem, the present invention introduces the concept of a standby shared Ethernet adapter. Turning now to FIG. 6, a diagram illustrating a primary shared Ethernet adapter and standby shared Ethernet adapter in a Virtual I/O server of a logically-partitioned data processing system is depicted in accordance with an illustrative embodiment of the present invention. As shown in FIG. 6, in an illustrative embodiment, the mechanism of the present invention may be implemented as part of the Virtual I/O server 600 using a virtual Ethernet adapter that is defined for the same subnet.

The mechanism of the present invention may set up standby shared Ethernet adapter (SEA) 604 by disabling path 611 from virtual trunk adapter 607 to physical Ethernet adapter 610, such that virtual trunk adapter 604 may receive external communications from primary SEA 602 through paths 612 and 613. Standby SEA 604 then monitors periodically for failure of primary SEA 602. Standby SEA 604 may monitor the failure by periodically sending a ping request to the Hypervisor, which recognizes whether destination of the ping request is in the same subnet. If the destination is not in the same subnet, the request is for external systems. Standby SEA 604 then monitors for a response of the ping request. If no response is received, primary SEA 602 has failed.

When standby SEA 604 detects a failure, standby SEA 604 activates its virtual Ethernet adapter 612 by connecting path 611 between physical adapter 610 and virtual adapter 612. Thus, standby SEA 604 now becomes the primary SEA and the Hypervisor will complete its action and all logical partitions, including LPAR 1, 2, and 3, will now be communicating with virtual Ethernet adapter 612 instead of virtual Ethernet adapter 608.

Later, when primary SEA 602 recovers, it performs similar steps as standby Ethernet adapter 604 to disable path 616 between its physical adapter 606 and virtual adapter 608. Primary SEA 602 then determines if external communications are received. Primary SEA 602 may determine if external communications are received by sending a ping request similar to one described above. If external communications are received, meaning that standby SEA 604 is up and running, primary SEA 602 takes no action. However, if no external communications are received, primary SEA 602 performs similar steps and activates its virtual adapter 608 by connecting path 616 between virtual adapter 608 and 606, such that LPAR 1, 2, and 3 are now communicating with virtual adapter 608.

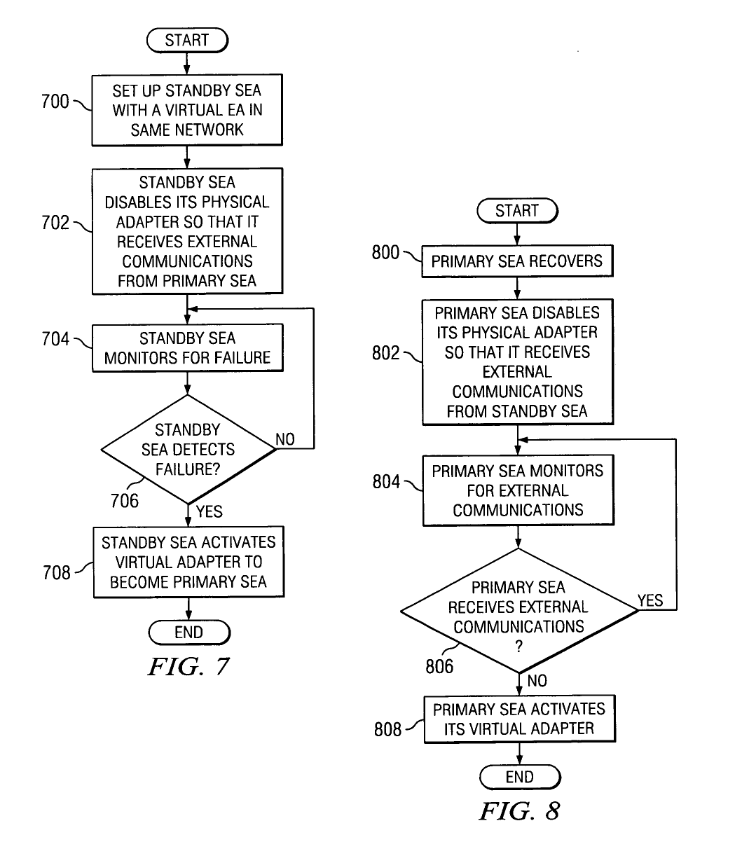

Turning now to FIG. 7, a flowchart of an exemplary process for automatically activating a standby shared Ethernet adapter is depicted in accordance with an illustrative embodiment of the present invention. As depicted in FIG. 7, the process begins when the mechanism of the present invention sets up a standby SEA with a virtual Ethernet adapter that belongs to the same network (step 700).

Next, the standby SEA disables its physical adapter, such that the standby SEA receives external communications from the primary SEA (step 702). This step may be performed by disabling the path between its physical adapter and the virtual adapter. The standby SEA then monitors for a failure periodically (step 704). For example, standby SEA may send a ping request and monitor for a response. Then, the standby SEA makes a determination as to whether the standby SEA detects the failure (step 706).

If no failure is detected, the process returns to step 704 to continue monitoring for a response. However, if a failure is detected, the standby SEA activates its virtual adapter (step 708) by connecting the path between its physical adapter and virtual adapter. Thus, the standby SEA is now a primary SEA. The process then terminates thereafter.

Turning now to FIG. 8, a flowchart of an exemplary process for reactivating a primary shared Ethernet adapter after recovery is depicted in accordance with an illustrative embodiment of the present invention. As depicted in FIG. 8, the process begins when the primary SEA recovers from its failure (step 800).

Next, the primary SEA disables its physical adapter, such that the primary SEA receives external communications from the standby SEA (step 802). This step may be performed by disabling the path between its physical adapter and the virtual adapter. The primary SEA then monitors for external communications (step 804). For example, the primary SEA may send a ping request and monitor for a response. Then, the primary SEA makes a determination as to whether external communications are received (step 806).

If external communications are received, the process returns to step 804 to continue monitoring for external communications. However, if no external communications are received, the primary SEA recognizes that the standby SEA is not providing connectivity and it activates its virtual adapter (step 808) by connecting the path between its physical adapter and virtual adapter. Thus, the primary SEA is now a primary SEA again. The process then terminates thereafter.

Thus, the present invention provides a mechanism for a standby shared Ethernet adapter that automatically activates its virtual adapter in case of a primary shared Ethernet adapter failure. In this way, failures may be detected automatically and failsafe functions may be provided at a granular level, which is the shared Ethernet adapter level, as opposed to the Virtual I/O server level.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a logically-partitioned data processing system for automatically activating a standby shared Ethernet adapter, the method comprising:
setting up the standby shared Ethernet adapter using a virtual Ethernet adapter, wherein the virtual Ethernet adapter belongs to a same network as a primary shared Ethernet adapter;
periodically monitoring external communications received at the standby shared Ethernet adapter from the primary shared Ethernet adapter for a failure; and
responsive to detecting a failure, activating the standby shared Ethernet adapter as the primary shared Ethernet adapter.

2. The method of claim 1, wherein the setting up step comprises:
disconnecting a path between a virtual trunk adapter and a physical adapter of the standby shared Ethernet adapter, wherein the standby shared Ethernet adapter receives external communications from the primary shared Ethernet adapter.

3. The method of claim 1, wherein the periodically monitoring step comprises:
periodically sending a ping request to a platform management firmware, wherein the platform management firmware recognizes destination of the ping request belonging to a same subnet;
determining if a response is received for the ping request; and
if no response is received, reporting a failure to the standby shared Ethernet adapter.

4. The method of claim 1, wherein the activating step comprises:
connecting a path between a virtual trunk adapter and a physical adapter of the standby shared Ethernet adapter by making a call to a platform management firmware, wherein the platform management firmware completes its operations and switches all client logical partitions in the logically-partitioned data processing system that were using the primary shared Ethernet adapter to the standby shared Ethernet adapter.

5. The method of claim 1, further comprising:
responsive to a recovery of the primary shared Ethernet adapter, setting up the primary shared Ethernet adapter to receive external communications from the standby shared Ethernet adapter;
determining if external communications are received from the standby shared Ethernet adapter; and
if no external communications are received from the standby shared Ethernet adapter, reactivating the primary shared Ethernet adapter.

6. The method of claim 5, wherein the setting up step comprises:
disconnecting a path between a virtual trunk adapter and a physical adapter of the primary shared Ethernet adapter, wherein the primary shared Ethernet adapter receives external communications from the standby shared Ethernet adapter.

7. The method of claim 5, wherein the determining step comprises:
sending a ping request to a platform management firmware, wherein the platform management firmware recognizes destination of the ping request belonging to a same subnet; and
detecting a response for the ping request from the standby shared Ethernet adapter.

8. The method of claim 5, wherein the reactivating step comprises:
connecting a path between a virtual trunk adapter and a physical adapter of the primary shared Ethernet adapter by making a call to a platform management firmware, wherein the platform management firmware completes its operations and switches all client logical partitions in the logically-partitioned data processing system that were using the standby shared Ethernet adapter to the primary shared Ethernet adapter.

9. A logically-partitioned data processing system comprising:
a bus;
a memory connected to the bus, wherein a set of instructions are located in the memory;
one or more processors connected to the bus, wherein the one or more processors execute a set of instructions to set up the standby shared Ethernet adapter using a virtual Ethernet adapter, wherein the virtual Ethernet adapter belongs to a same network as a primary shared Ethernet adapter; periodically monitor external communications received at the standby shared Ethernet adapter from the primary shared Ethernet adapter for a failure; and activate the standby shared Ethernet adapter as the primary shared Ethernet adapter responsive to detecting a failure.

10. The logically-partitioned data processing system of claim 9, wherein the one or more processors, in executing the set of instructions to set up the standby shared Ethernet adapter using a virtual Ethernet adapter, disconnect a path between a virtual trunk adapter and a physical adapter of the standby shared Ethernet adapter, wherein the standby shared Ethernet adapter receives external communications from the primary shared Ethernet adapter.

11. The logically-partitioned data processing system of claim 9, wherein the one or more processors, in executing the set of instructions to periodically monitor external communications received at the standby shared Ethernet adapter from the primary shared Ethernet adapter for a failure, periodically send a ping request to a platform management firmware, wherein the platform management firmware recognizes destination of the ping request belonging to a same subnet; determine if a response is received for the ping request; and report a failure to the standby shared Ethernet adapter if no response is received.

12. The logically-partitioned data processing system of claim 9, wherein the one or more processors, in executing the set of instructions to activate the standby shared Ethernet adapter as the primary shared Ethernet adapter, connects a path between a virtual trunk adapter and a physical adapter of the standby shared Ethernet adapter by making a call to a platform management firmware, wherein the platform management firmware completes its operations and switches all client logical partitions in the logically-partitioned data processing system that were using the primary shared Ethernet adapter to the standby shared Ethernet adapter.

13. The logically-partitioned data processing system of claim 9, wherein the one or more processors further execute the set of instructions to set up the primary shared Ethernet adapter to receive external communications from the standby shared Ethernet adapter responsive to a recovery of the primary shared Ethernet adapter; determine if external communications are received from the standby shared Ethernet adapter; and reactivate the primary shared Ethernet adapter if no external communications are received from the standby shared Ethernet adapter.

14. The logically-partitioned data processing system of claim 13, wherein the one or more processors, in executing the set of instructions to set up the primary shared Ethernet adapter to receive external communications from the standby shared Ethernet adapter, disconnect a path between a virtual trunk adapter and a physical adapter of the primary shared Ethernet adapter to receive external communications from the standby shared Ethernet adapter.

15. The logically-partitioned data processing system of claim 13, wherein the one or more processors, in executing the set of instructions to determine if external communications are received from the standby shared Ethernet adapter, send a ping request to a platform management firmware, wherein the platform management firmware recognizes destination of the ping request belonging to a same subnet; and detect a response for the ping request from the standby shared Ethernet adapter.

16. The logically-partitioned data processing system of claim 13, wherein the one or more processors, in executing the set of instructions to reactivate the primary shared Ethernet adapter if no external communications are received from the standby shared Ethernet adapter, connect a path between a virtual trunk adapter and a physical adapter of the primary shared Ethernet adapter by making a call to a platform management firmware, wherein the platform management firmware completes its operations and switches all client logical partitions in the logically-partitioned data processing system that were using the standby shared Ethernet adapter to the primary shared Ethernet adapter.

17. A computer program product in a computer-readable medium for automatically activating a standby shared Ethernet adapter, the computer program product comprising:
first instructions for setting up the standby shared Ethernet adapter using a virtual Ethernet adapter, wherein the virtual Ethernet adapter belongs to a same network as a primary shared Ethernet adapter;
second instructions for periodically monitoring external communications received at the standby shared Ethernet adapter from the primary shared Ethernet adapter for a failure; and
third instructions for activating the standby shared Ethernet adapter as the primary shared Ethernet adapter responsive to detecting a failure.

18. The computer program product of claim 17, wherein the first instructions comprises sub-instructions for disconnecting a path between a virtual trunk adapter and a physical adapter of the standby shared Ethernet adapter, wherein the standby shared Ethernet adatper receives external communications from the primary shared Ethernet adapter; and
wherein the third instructions comprises sub-instructions for connecting a path between a virtual trunk adapter and a physical adapter of the standby shared Ethernet adapter by making a call to a platform management firmware, wherein the platform management firmware completes its operations and switches all client logical partitions that were using the primary shared Ethernet adapter to the standby shared Ethernet adapter.

19. The computer program product of claim 18, further comprising:
fourth instructions for setting up the primary shared Ethernet adapter to receive external communications from the standby shared Ethernet adapter responsive to a recovery of the primary shared Ethernet adapter;
fifth instructions for determining if external communications are received from the standby shared Ethernet adapter; and
sixth instructions for reactivating the primary shared Ethernet adapter if no external communications are received from the standby shared Ethernet adapter.

20. The computer program product of claim 19, wherein the fourth instructions comprises sub-instructions for connecting a path between a virtual trunk adapter and a physical adapter of the primary shared Ethernet adapter by making a call to a platform management firmware, wherein the platform management firmware completes its operations and switches all client logical partitions that were using the standby shared Ethernet adapter to the primary shared Ethernet adapter; and
wherein the sixth instructions comprises sub-instructions for disconnecting a path between a virtual trunk adapter and a physical adapter of the standby shared Ethernet adapter to receive external communications from the primary shared Ethernet adapter.
